(19) United States
(12) Patent Application Publication
(10) Pub. No.: US 2024/0378371 A1
(43) Pub. Date: Nov. 14, 2024

(54) DYNAMIC PRESENTATION OF CONTENT SUGGESTIONS FOR ANNOTATION

(71) Applicant: Apple Inc., Cupertino, CA (US)

(72) Inventors: Adeeti V. ULLAL, Los Altos, CA (US); Allison L. GILMORE, Redwood City, CA (US); Pejman Lotfali KAZEMI, San Francisco, CA (US); Yann J. RENARD, San Diego, CA (US); Hyo Jeong SHIN, San Jose, CA (US); Guanling FENG, Santa Clara, CA (US); Alexander G. BRUNO, Cupertino, CA (US); Jaehyun BAE, San Carlos, CA (US); Ayse S. CAKMAK, Santa Clara, CA (US)

(21) Appl. No.: 18/438,395

(22) Filed: Feb. 9, 2024

Related U.S. Application Data
(60) Provisional application No. 63/465,061, filed on May 9, 2023.
(60) Provisional application No. 63/470,972, filed on Jun. 4, 2023.

(51) Int. Cl. G06F 40/166; G06F 3/0483; G06F 16/35

(52) U.S. Cl. CPC G06F 40/166; G06F 3/0483; G06F 16/355

(57) ABSTRACT

The subject technology provides a framework for generating personalized and relevant content suggestions for a user of an electronic device. The system collects data from various sources, including location, motion sensors, routine places, contacts, calls, and proximity to people and devices. The collected data is analyzed using inference technology to identify patterns and anomalies. The system can detect routine activities and identify anomalies based on the duration and frequency of activities, social interactions, and changes in user behavior. The system includes modules for grouping related activities and summarizing individual events and coarse-grained activities. The system also includes a ranking algorithm that generates recommendations based on various factors such as recency, distinctiveness, media richness, and user engagement. The system further includes a method of adjusting recommendation ranking based on prior analytics and user preferences.

### CROSS-REFERENCE TO RELATED APPLICATION(S)

This application claims the benefit of U.S. Provisional Application Ser. No. 63/470,972, entitled “DYNAMIC PRESENTATION OF CONTENT SUGGESTIONS FOR ANNOTATION” and filed on Jun. 4, 2023, and U.S. Provisional Application Ser. No. 63/465,061, entitled “DYNAMIC PRESENTATION OF CONTENT SUGGESTIONS FOR ANNOTATION” and filed on May 9, 2023, the disclosures of which are expressly incorporated by reference herein in their entirety.

### TECHNICAL FIELD

The present description generally relates to electronic devices, and more particularly to dynamic presentation of content suggestions for annotation on electronic devices.

### BACKGROUND

Journals and diaries have long been a popular way for individuals to reflect on their lives and document their experiences.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates an example electronic device that may implement a system for providing dynamic presentation of content suggestions for annotation in a journaling platform in accordance with one or more implementations.

FIGS. 3A, 3B, and 3C illustrate an example computing architectures for a system providing dynamic presentation of content suggestions for annotation in accordance with one or more implementations.

FIGS. 4A and 4B are flow charts of an example process that may be performed for dynamic presentation of content suggestions for annotation in accordance with one or more implementations.

FIG. 5 illustrates an example computing architecture for a system ranking content suggestions in accordance with one or more implementations.

FIG. 6 is a flow chart of an example process that may be performed for ranking content suggestions in accordance with one or more implementations.

FIG. 7 illustrates an example use case in which time-sorted content suggestions for annotation are generated based on a user activity timeline in accordance with one or more implementations.

FIG. 8 illustrates an example use case in which content suggestions for annotation are generated to recommend a journaling entry for a user in accordance with one or more implementations.

FIG. 9 illustrates an example computing architecture for a system providing dynamic presentation of content suggestions for annotation using machine learning in accordance with one or more implementations.

FIG. 10 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Journaling has been a well-known tool for personal development and has been used for many years as a means to record thoughts, memories, and life events. In recent years, there have been attempts to bridge the gap between traditional journaling and digital technology by developing journaling applications that offer smart journaling suggestions to users. These applications aim to make journaling more accessible and convenient for users, allowing them to create a personal record of their lives in a fun and engaging way. With the increasing use of mobile devices, there is the possibility for personalized and concise views of a user's life based on sensor data collected from their user device. However, current systems lack the ability to detect unusual patterns in user activities, group related activities into bundles, and generate recommendations based on ranking algorithms that consider various factors such as media richness, user engagement, and diversity. Therefore, there may be a need for a system and method that can provide a more personalized and relevant view of a user's life and generate recommendations for journaling based on a user's preferences.

In one or more implementations, a journaling platform may operate, at least in part, on a user device. Upon opening a journaling application associated with the journaling platform, the user may be presented with the option to create a new journal entry or view previous journal entries. If the user chooses to create a new entry, the journaling application can prompt the user to select a life moment from a list of suggestions based on their life content. For example if a trip bundle is created, once the user selects that bundle for writing, the journaling platform can display something like: “What about your trip is likely to stick with you?” Using prior journal entry context to inform a specific prompt can help make it easier to start writing and promote reflection. In some implementations, the journaling application can analyze data obtained from the user's previous journal entries, mood logs, and other data sources to identify significant events or occurrences in the user's life. In other implementations, the journaling application can parse through base content on a user's device (e.g., photos, workouts, location data, mood states, etc.) and aggregate content that appears to be related to a particular event (i.e., without knowing if there was an event or not). In this regard, the journaling application can identify events based on less explicit signaling obtained from the user's device. The journaling application can then suggest personalized and relevant content suggestions to users based on these identified life moments.

For example, if the data accessible by the journaling application indicates that a user has recently traveled, the journaling application would suggest creating a travel journal entry. Similarly, if the data indicates that a user has achieved a significant milestone, the journaling application may prompt the user to write about their experience. These content suggestions can be customized according to the user's preferences. For example, this feature can be achieved by analyzing the user's content, such as photos, videos, and other multimedia, and providing suggestions based on the user's interests and preferences. In this regard, if a trip bundle is created, once the user selects that bundle for writing, the journaling application may display something like: “What about your trip is likely to stick with you?” Using prior journal entry context to inform a specific prompt can help make it easier to start writing and promote reflection. In some aspects, the suggestions include content from the users' device, e.g. photos, workout records, maps, etc. The journaling application may use machine learning algorithms to analyze the user's content and identify relevant life moments that the user may want to document. The subject technology can use natural language processing and machine learning techniques to generate content suggestions that identify significant events or occurrences in the user's life. This personalized approach to journaling can encourage users to continue the practice over time.

The subject technology may include a system for analyzing and summarizing data gathered from various sensors and/or data sources on a user device. In some aspects, the system includes a plurality of sensors for detecting a user's location, motion, routine places, contacts, calls, and proximity to other devices. For example, the subject technology can use a combination of pattern detection, people detection, and location inference to detect if a user is around an unusual number of people, for example hosting guests at home for a party. In some aspects, the system is configured to concurrently analyze data obtained from multiple sensors, providing a more comprehensive view of the user's behavior and patterns. The system may also use a trained machine learning model to improve its performance over time, becoming more accurate at detecting routine events, anomalous events, and unusual patterns. This is because anomalous events and/or unusual patterns may be indicative of an event that the user may wish to journal. The system further includes an inference model for determining whether the user is close to a device associated with a notable person in their life, as well as detecting unusual patterns in the user's behavior.

The subject technology provides for a system that incorporates personalized and relevant suggestions based on life moments for a journaling platform. The subject technology provides a unique and innovative approach to journaling by using automatic smart journaling suggestions based on life moments. For example, the subject technology aims to improve smart journaling technology by automatically identifying and aggregating different types of content related to an event for journaling, thereby reducing the amount of time needed to find and correlate such content while also reducing the memory and processor consumption associated therewith. These benefits therefore are understood as improving the computing functionality of a given electronic device.

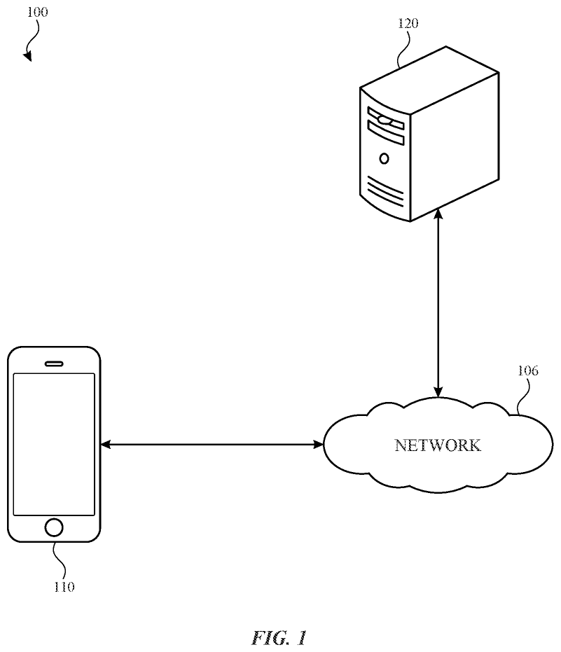

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, and the server 120; however, the network environment 100 may include any number of electronic devices and any number of servers.

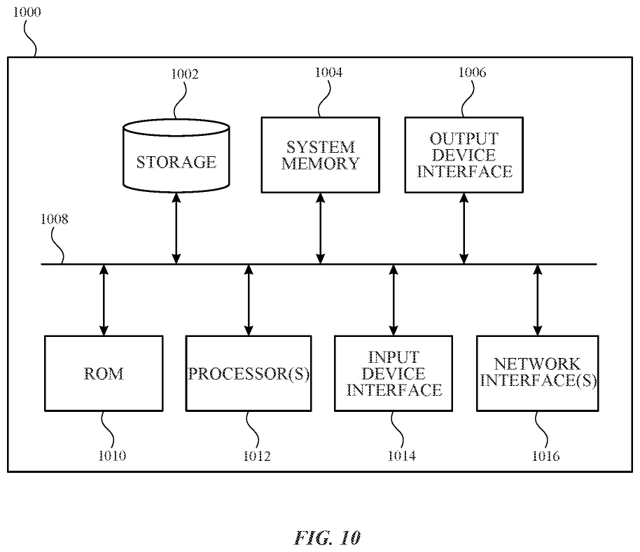

The electronic device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 10.

In one or more implementations, the electronic device 110 may provide a system for training a machine learning model using training data, where the trained machine learning model is subsequently deployed to the electronic device 110. Further, the electronic device 110 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output. In one or more implementations, training and inference operations that involve individually identifiable information of a user of the electronic device 110 may be performed entirely on the electronic device 110, to prevent exposure of individually identifiable data to devices and/or systems that are not authorized by the user.

The server 120 may provide a system for training a machine learning model using training data, where the trained machine learning model is subsequently deployed to the server 120 and/or to the electronic device 110. In an implementation, the server 120 may train a given machine learning model for deployment to a client electronic device (e.g., the electronic device 110). In one or more implementations, the server 120 may train portions of the machine learning model that are trained using (e.g., anonymized) training data from a population of users, and the electronic device 110 may train portions of the machine learning model that are trained using individual training data from the user of the electronic device 110. The machine learning model deployed on the server 120 and/or the electronic device 110 can then perform one or more machine learning algorithms. In an implementation, the server 120 provides a cloud service that utilizes the trained machine learning model and/or continually learns over time.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users.

In one or more implementations, a journaling platform may be implemented over the network environment 100, and the journaling platform may include two or more primary components, such as a client component and a server component. The client component may serve as the user-facing application that runs on a user device (e.g., the electronic device 110), while the server component serves as the backend infrastructure that stores and processes data on the server 120.

When a user interacts with the journaling application, the user is interacting with the client component. The application running on the electronic device 110 can provide a user interface for the user to create, edit, and view journal entries. The journaling application also may interact with the server 120 to store and retrieve data. In one or more implementations, when a user creates a new journal entry, the journaling application may store the journal entry in an encrypted container at the server 120, such that the journal entry is only accessible (i.e., decryptable) by the electronic device 110. Similarly, when a user wants to view their past journal entries, the journaling application can send a request to the server 120 to retrieve the encrypted journal entries.

The client component of the journaling application may be responsible for storing and processing data in some implementations. When a user creates a new journal entry, the electronic device 110 can store the journal entry in an encrypted container that is only accessible by the electronic device 110. In some implementations, the electronic device 110 can perform processing on the data to generate personalized content suggestions for recommending to the user. For example, the electronic device 120 may analyze data indicating the user's previous entries to identify recurring themes or topics of interest. Based on this analysis, the electronic device 110 can generate personalized content suggestions that are relevant and meaningful to the user.

In one or more implementations, the electronic device 110 can use machine learning algorithms to implement the personalized prompts feature. The machine learning algorithms can analyze data indicating the user's previous entries and identify patterns in the data. The machine learning algorithms can then use these identified patterns to generate content suggestions for new journal entries. The electronic device 110 can also use natural language processing (NLP) techniques to analyze data indicating the user's writing style and generate prompts that are tailored to their preferences. In one or more implementations, one or more of the operations performed by the electronic device 110 may be performed by the server 120.

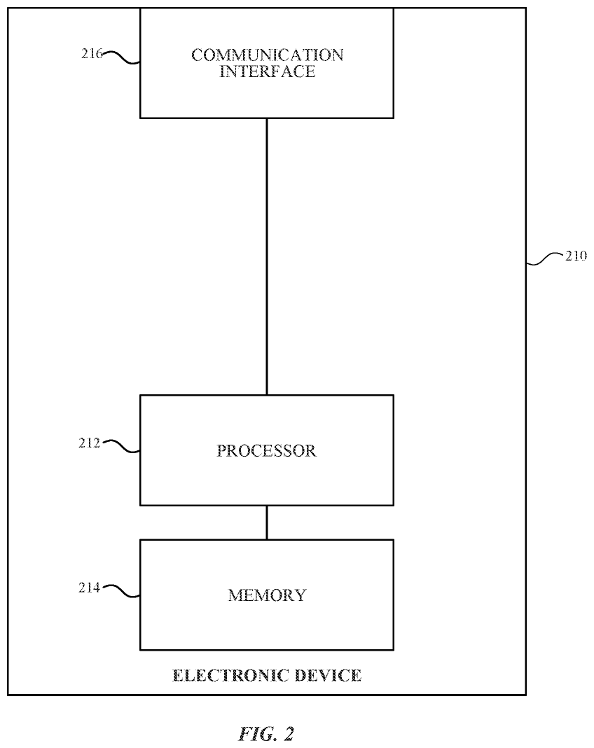

FIG. 2 illustrates an example electronic device 102 that may implement a system for providing dynamic presentation of content suggestions for annotation in a journaling platform in accordance with one or more implementations. For example, the electronic device 210 of FIG. 2 can correspond to the electronic device 110, and/or to the server 120 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 210 may include a processor 212, a memory 214, a sensor 216, and communication interface 218. The processor 212 may include suitable logic, circuitry, and/or code that enable processing data and/or controlling operations of the electronic device 210. In this regard, the processor 212 may be enabled to provide control signals to various other components of the electronic device 210. The processor 212 may also control transfers of data between various portions of the electronic device 210. Additionally, the processor 212 may enable implementation of an operating system or otherwise execute code to manage operations of the electronic device 210.

The memory 214 may include suitable logic, circuitry, and/or code that enable storage of various types of information such as received data, generated data, code, and/or configuration information. The memory 214 may include, for example, random access memory (RAM), read-only memory (ROM), flash, and/or magnetic storage. The sensor 216 may be an image sensor, a positioning sensor (e.g., accelerometer, GPS, etc.), a proximity sensor (e.g., Bluetooth, WiFi Aware, etc.).

The communication interface 218 may include suitable logic, circuitry, and/or code that enables wired or wireless communication, such as the electronic device 110 and/or the server 120 over the network 106. The communication interface 218 may include, for example, one or more of a Bluetooth communication interface, a cellular communication interface (e.g., 3G, 4G, LTE, 5G, etc.), an NFC interface, a Zigbee communication interface, a WLAN communication interface (e.g., Wi-Fi, WLAN/BT combination, WiMAX, LiFi, 2.4 GHz, 5 GHz, etc.), a USB communication interface, an Ethernet communication interface, a millimeter wave (e.g., 60 GHz) communication interface, or generally any communication interface.

In one or more implementations, one or more of the processor 212, the memory 214, the communication interface 218, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

The subject technology may be implemented in software, firmware, or hardware and may be embodied in a variety of different devices, including but not limited to smartphones, tablets, wearables, and other mobile computing devices. The subject technology may also be implemented as a cloud-based service, allowing users to access and analyze their data from any device with an Internet connection.

The present disclosure pertains to presenting personalized and relevant smart suggestions to users to enhance their journaling experience. The suggestions are based on private user data accessed locally on the user's device (e.g., the electronic device 110), such as location data, activity tracking, music listening history, chat logs, and the like. This data is used to suggest content related to the user's experiences, activities, and interactions. A journaling app of the subject technology includes a feature for grouping related content together, such as photos and notes from a visit to the pediatrician, and automatically bundling them into a single suggestion to provide context and inspiration for the user's journal entry. The suggestions are time-organized, with recent suggestions appearing at the top of the list. The user can rate or rank the suggestions, and the system can learn from these ratings to improve the quality of suggestions over time. For example, the journaling app includes a “recommended” tab, which displays the smartest and most relevant suggestions for the user based on their ratings (e.g., rating on each bundle factor such as recency, richness, distinctness, quality score, heuristics) and interactions with the journaling app. The present disclosure provides a novel and intuitive approach to enhancing the journaling experience, increasing the likelihood that users will be provided with relevant suggestions and will then write about their life experiences and record their thoughts.

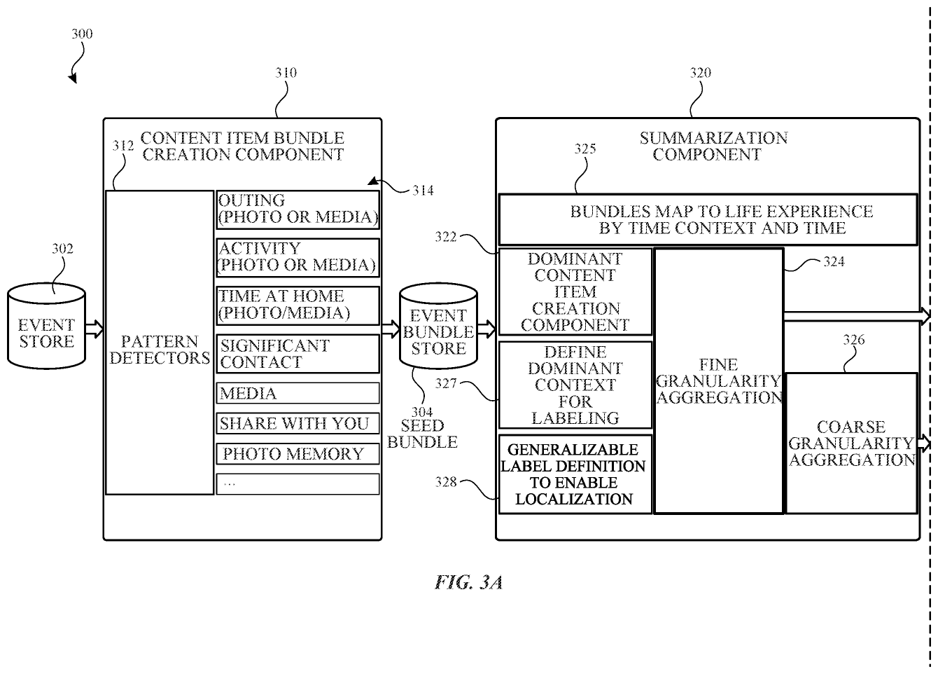

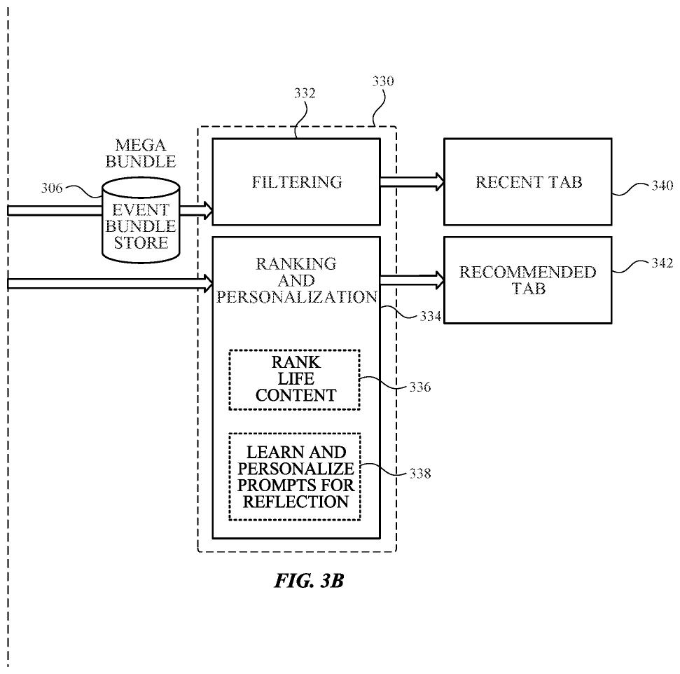

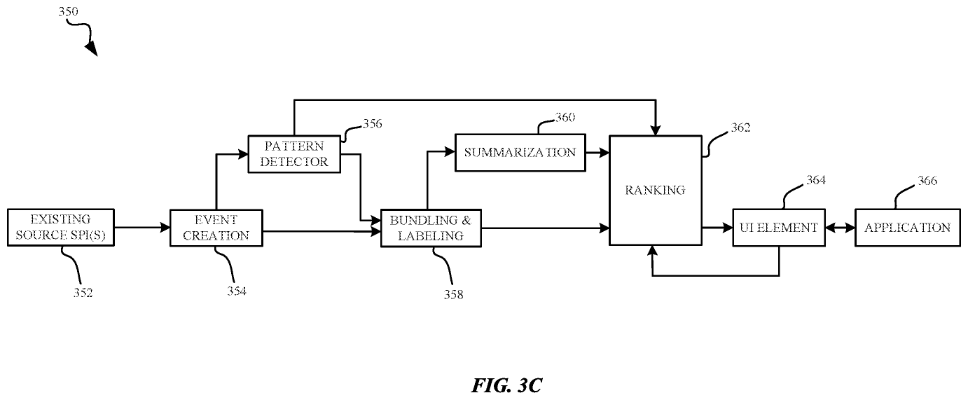

FIGS. 3A and 3B illustrate an example computing architecture for a system 300 providing dynamic presentation of content suggestions for annotation in accordance with one or more implementations. In one or more implementations, the system 300 may be implemented all or in part by the electronic device 120. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As illustrated in FIG. 3A, the system 300 includes an event store repository 302, a content item bundles creation component 310, a first event bundle store repository 304, a summarization component 320. As illustrated in FIG. 3B, the system 300 also includes a second event bundle store repository 306 and a filtering and ranking component 330. In one or more implementations, the first event bundle store repository 304 is located between the content item bundles creation component 310 and the summarization component 320. In one or more other implementations, the first event bundle store repository 304 is located after the summarization component 320.

In one or more implementations, the system 300 can perform a method of generating life highlights and content suggestions based on sensor data collected from a user device. The system 300 can detect unusual patterns in a user's activities and social interactions based on sensed signals from various sources, such as location sensors, image sensors, proximity sensors, and the like, which may be an indication that the unusual pattern relates to an event that the user may wish to journal about. The system 300 can utilize inference technology to determine if a user is close to a device associated with a person in their life. Additionally, the system 300 can detect routine activities, trends and anomalies in a user's life to provide a more personalized view of their life.

The system 300 collects data from multiple sources, including location sensors, image sensors, proximity sensors, contacts, calls, mood and/or emotion logs, and proximity to devices and devices associated with notable people in the user's life. The collected data is stored in the event store repository 302. In one or more implementations, the system 300 employs a privacy-preserving approach to data storage, which safeguards sensitive data while still enabling the system to generate personalized suggestions. The architecture of the system 300 is designed to provide a personalized experience to each user while keeping sensitive data secure. Most of the processing is performed on the user's device, with certain data, such as photos and health kit data, potentially being backed up to a network cloud, e.g., in an encrypted storage container that is only accessible by the user's device. In some aspects, each of the repositories of the system 300 (e.g., event store repository 302, first event bundle store repository 304, second event bundle store repository 306) may not actually store the data itself, but instead store references to the data that exists in other virtual private servers (VPS). This can ensure that user data is kept secure and not vulnerable to potential security breaches, and/or accessible to servers. In one or more implementations, the repositories 302, 304, 306 may be the same data repository with the individual repositories 302, 304, 306 representing logical segmentations of the data stored in the repository.

The content item bundles creation component 310 includes a preprocessing component 312. The preprocessing component 312 receives the collected data from the event store repository 302 and detects unusual patterns in user activities and social interactions based on user content in the collected data. For example, the collected data is analyzed using pattern detection algorithms for routine detection, anomaly detection, trend detection, and the duration and frequency of activities, social interactions, and changes in user behavior. The subject technology uses the pattern detection algorithms to detect routine and anomalous events, as well as the length of time the user engages in specific activities, talks to specific people, etc. For example, the system may determine whether it is unusual for the user to have not spoken to their mother in a certain amount of time or whether the user's current walk is unusually long. Pattern detection can also run on mood data to identify anomalies, trends, or consistent states. In one or more implementations, a detected anomaly may correspond to an unusual event (e.g., for the user) that the user may wish to journal about.

In one or more implementations, the system 300 uses a range of machine learning models to produce personalized recommendations for users. These machine learning models can be trained on various types of data, such as user behavior and preferences, to generate personalized suggestions for users. Furthermore, the machine learning models operate in a privacy-preserving manner to ensure that sensitive data is protected.

In one or more implementations, the preprocessing component 312 utilizes machine learning algorithms to learn and adapt to the user's behavior. It can detect changes in the user's routine and identify unusual activities or interactions. For example, if a user usually calls their mother every day, but suddenly stops calling for several days, the preprocessing component 312 can detect this change and flag it as unusual. Similarly, if a user starts spending more time in a particular location, the preprocessing component 312 can detect this change and identify it as unusual.

The preprocessing component 312 can also detect social anomalies based on changes in user behavior. For example, if the preprocessing component 312 analyzes private user data (e.g., phone data, location data, and the like) that indicates a user suddenly starts interacting more frequently with someone they do not usually talk to, the preprocessing component 312 can detect this change and flag it as unusual. The preprocessing component 312 can also identify unusual patterns in the duration and frequency of social interactions, such as a sudden increase or decrease in the number of calls or texts.

In one or more implementations, the system 300 provides users with alerts and recommendations for journaling based on the unusual patterns detected. For example, if the preprocessing component 312 detects that the user has called their mother at an unusual time (e.g., for the user), the system 300 may detect that the user may have called to discuss something important that the user would want to journal about, and therefore, suggest content relating to that discussion to journal about. Similarly, if the preprocessing component 312 detects unusual behavior from a person in the user's contact list, the system 300 may suggest content relating to that contact to journal about.

The subject technology also includes a content item bundles creation component that groups events and activities into bundles to represent a single event or a series of related activities. The system may also associate content item bundles with certain outings, such as going to the park and then a coffee shop. For example, the content item bundles creation component 310 groups related activities and events into a bundle and compartmentalizes the content item bundles associated with different types of events and/or activities. For example, the content item bundles creation component 310 can generate different content item bundles 314, which may include, but are not limited to, an outing content item bundle, an activity content item bundle, a time-at-home content item bundle, a significant contact content item bundle, a media content item bundle, a share-with-you content item bundle, a photo memory content item bundle, among others. In some aspects, a given content bundle may include different types of user content (e.g., photos, maps, workout logs, etc.). In one or more implementations, bundles can be created directly from a user's mood or emotion logs. In one or more other implementations, mood or emotion context can be appended to existing bundles. The content item bundles 314 can be stored in the first event bundle store repository 304. In some aspects, the term “content item bundle” may be referred to as a “seed bundle.”

In one or more implementations, the summarization component 320 may determine a primary label corresponding to at least one of the content item bundles 314 in a group of content item bundles. For example, the summarization component 320 may analyze the content item bundles 314 and define the primary user activity context detected among the content item bundles 314 for labeling. In some aspects, the primary label is indicative of the primary user activity across the content item bundles 314. In one or more implementations, the summarization component 320 includes a primary content item bundle creation component 322 to determine a primary content item bundle among the content item bundles 314 stored in the first event bundle store repository 304 by selecting the content item bundle associated with the primary user activity context and assigning the primary label to the selected content item bundle. In some aspects, the primary content item bundle may be defined (or represented) by the primary label. In some aspects, the primary content item bundle creation component 322 may further associate the content item bundles 314 with different types of events to determine the primary content item bundle for a group of related activities. The summarization component 320 also includes a fine-grained aggregation component 324 and a coarse-grained aggregation component 326. The fine-grained aggregation component 324 performs fine granularity summarization of a user's activities, allowing for individual event viewing. The coarse-grained aggregation component 326 performs coarse granularity summarization, aggregating together activities based on common factors such as the same person or a single long outing that goes to multiple places. The fine-grained summarization and coarse-grained summarization of content item bundles are stored in the second event bundle store repository 306.

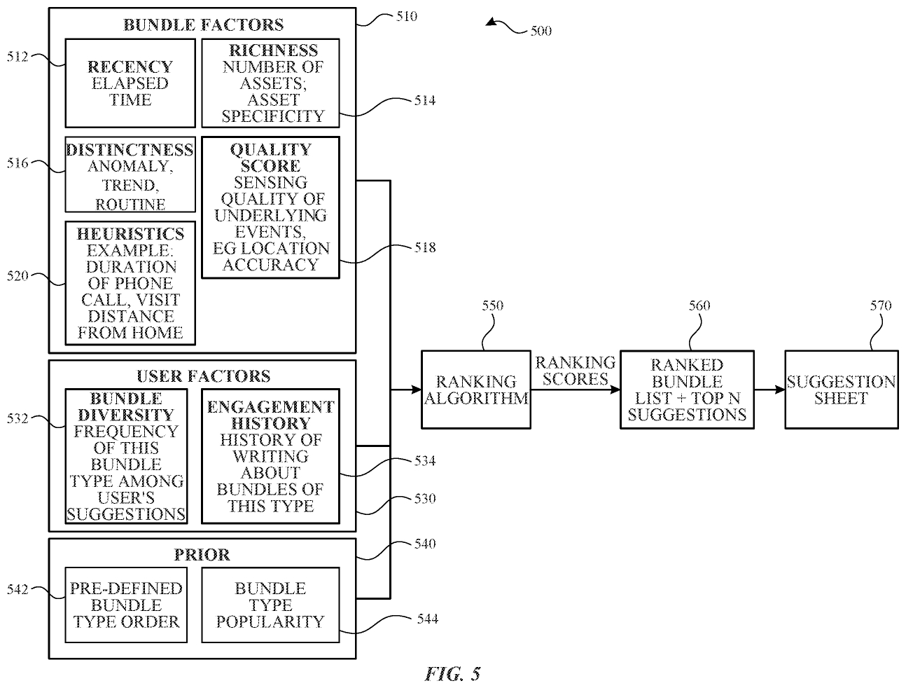

As illustrated in FIG. 3B, the filtering and ranking component 330 includes a filtering component 332 and a ranking and personalization component 334. The filtering component 332 can filter through the fine-grained summarization and/or coarse-grained summarization of content item bundles stored in the second event bundle store repository 306. The ranking and personalization component 334 generates recommendations based on a ranking algorithm that considers factors such as recency, distinctiveness, heuristics, media richness, quality score, user engagement, and diversity. The ranking algorithm will be discussed in more detail with reference to FIG. 5. In a use case, the system 300 detects visits to new places or infrequently visited places via the preprocessing component 312 and considers the richness of media assets related to an activity via the ranking and personalization component 334 when generating recommendations. Here, visiting a new place or an infrequently visited place may be an indication of an event that the user may wish to journal about. Additionally, the ranking and personalization component 334 provides for detecting diversity in recommendations to ensure variety in the suggestions. In some aspects, the filtered results are provided for display on a “recent” tab in the user interface (UI) of the journaling app. In other aspects, the ranked results are provided for display on a “recommended” tab of the journaling app.

In one or more implementations, the system 300 also provides for adjusting recommendation ranking based on prior analytics and user preferences. The ranking and personalization component 334 can detect trends in a user's activities and social interactions to provide more personalized recommendations.

One of the data sources for the data collected by the system 300 is user activity data, which is captured using passively sensed cues based on location, motion activity, and device proximity to other users. This data is used to populate the event store repository 302 with timestamped data representing a user's actions throughout the day. The system 300 may utilize, for example, GPS and/or Wi-Fi signals to determine a user's location throughout the day, even when the user is not actively using a location-based application. This information can be used to create “significant locations,” which are then used to group events together. In some aspects, a significant location may be defined as a location associated with a primary user activity. Similarly, the system 300 uses motion activity sensors to determine a user's activity, such as whether a user is walking, driving, cycling or other user activity, and uses this information to further classify events.

The system 300 also collects data from applications to capture user activity. For example, the system 300 can receive event streams from music streaming application or physical activity tracking applications when a user listens to music or completes a workout. Additionally, the system 300 can receive donations from other applications through a share sheet, which allows users to easily share content from one application to another. This data may be referred to as assets, which are various types of media and information that are displayed in the suggestion user interface of the journaling application. These assets can come from different sources, such as photos, maps, activity rings, workout icons, and even media associated with a workout, like podcasts. Suggestions that have more and diverse assets tend to be more interesting and popular, which is used as an indicator for the ranking algorithm in the ranking and personalization component 334. The assets can be accessed from upstream applications, and depending on the type of suggestion, various applications may contribute to the assets. For example, if a user writes a workout to a workout-related application, the information can be pulled from and/or donated by the workout-related application.

The pattern detection performed by the preprocessing component 312 may be a process of identifying recurring patterns or anomalies in data by using statistical algorithms. In one or more implementations, the pattern detection algorithm may identify anomalies and flag them for further review. In one example, pattern detection is used by the preprocessing component 312 to filter and process a large amount of data generated by different types of signals, such as text messages, chats, music, and location data being collected and stored in the event store repository 302. The preprocessing component 312 is used to preprocess and pattern detect these signals to filter out noise and identify useful data, such as data that may be indicative of an event that the user may wish to journal about.

In another example, the pattern detection is used by the preprocessing component 312 to create content suggestions and to prompt the user to write about their personal life moments relating to the content suggestions in a journal. The preprocessing component 312 may start by identifying a time window, which is then adjusted based on other context information such as location and movement. These time windows may then be used by the content item bundles creation component 310 to create the content item bundles 314, which are groups of related data that represent a potential content suggestion.

The pattern detection performed by the preprocessing component 312 may use statistical models serving as pattern detectors, and those parameters associated with the models may be population-learned. The pattern detectors that are population-learned may be configured to check for deviations from expected patterns and flag them for further investigation. For instance, if two people typically have a phone call every week, but there is a three-week gap between calls, this would be considered an anomaly, and the pattern detector would identify it as an outlier. There are other pattern detectors that work in the opposite way, identifying patterns that always happen every week at the same time. These pattern detectors can help to increase the robustness of the analysis by providing more information about what is considered normal for a particular data set.

In one or more other implementations, the pattern detection performed by the preprocessing component 312 may monitor various contextual information and identifies individual trips or a series of trips. In some aspects, a trip suggestion captures a series of memorable experiences in various places. These trip-based suggestions can be detected using multiple sources of information, such as location context (e.g., distance from home town or familiar places, travel time to get to the destination, time zone shift, mode of transportation), social context (e.g., neighborhood where a user grew up, neighborhood where their family lives, location of a vacation home), travel plan context (e.g., calendar event, purchased flight/transportation tickets, hotel booking records), world wide context (e.g., well known landmarks where people would like to visit), and behavioral context (e.g., photos the user takes, voice records). When a trip lasts for an extended period, the trips can be grouped together based on the predominant context of each moment. For instance, if the device moves to a different city, state, country, or covers a significant distance, the trips can be presented as multiple suggestions. If the device can travel via a road network, covering multiple cities, it can be identified as a road trip.

In one or more implementations, the pattern detectors may be specified based on which variables are defined via an application configuration, and the preprocessing component 312 uses statistical tests on historical data to identify patterns and anomalies. For example, the preprocessing component 312 may detect an anomalous workout and adjust an associated quality score accordingly. The pattern detectors can operate in different ways, depending on the nature of the data being analyzed, and multiple pattern detectors can be used together to increase the robustness of the analysis.

In one or more implementations, these pattern detectors may be, or include at least a portion of, a machine learning model that is trained on a per-user basis, meaning that the pattern detection algorithm builds up a model of each individual user's behavior over time and uses this as a baseline for pattern matching. By doing so, the pattern detection algorithm can detect unusual behavior that may be indicative of a problem or an opportunity to suggest a new activity or event.

The bundling performed by the content item bundles creation component 310 may be a process of grouping related assets or events together to create a more comprehensive and summarized view of the data. In some aspects, the content item bundles may be grouped (or bundled) based on a commonality in one or more of time or location between each of the content item bundles. For example, the content item bundles creation component 310 clusters the content item bundles 314 based on one or more parameters (e.g., one or more of proximity in time and location, bundle ranking factors, user ranking factors, theme, user demographics, population density, or environment type), with learned decisions made about when to create boundaries between the clusters. In this regard, the content item bundles creation component 310 can use a combination of pattern detection, people detection, and location inference to detect if a user is around an unusual number of people, for example hosting guests at home for a party. The content item bundles creation component 310 attempts to create the most accurate summary of a person's daily activities by clustering similar activities together. In some aspects, bundling can involve creating collections of user events that include content indicative of a suggestion for journaling. These events can include activities, such as visiting a place, listening to music, or having a phone call, all of which are related to a specific user and their habits.

The content item bundles creation component 310 can apply clustering algorithms to group events together based on time, context, and other cues. The clustering can be based on location or context cues, and it helps to create “seeds” of data that can be combined in time and location to form bundles of related information. These content item bundles are then used for summarization (e.g., as described in connection with the summarization component 320).

The content item bundles creation component 310 may utilize a bundling algorithm that is responsible for creating different types of bundles (e.g., the content item bundles 314) based on the type of suggestion being made. For example, workout-related content item bundles may include information on exercise routines, workout activity rings, and maps of running routes. The media-related bundles may include photos, music, and video content. The outing-related content item bundles may include information on places visited, people met, and activities performed.

After events (or seeds) have been clustered (or bundled), the system can summarize the data to provide insights to the user. For example, the summarization component 320 may generate a summary of a user's day containing a listing of different primary user activities occurring in that day, including significant locations visited and people they interacted with. The summarization component 320 can also use context cues to generate more personalized summaries, such as grouping together events involving specific groups of people or locations. In some aspects, a summarization engine 325 is used to map the content item bundles to life experiences of the user by time context and/or theme. For example, the summarization component 320, using the summarization engine 325, can generate a summary of a user's trip or vacation that encompasses insights into the user's activities during the trip or vacation such as visited locations over a span of time of the trip and the user's interactions with other people during the trip. Overall, the summarization component 320 aims to provide a comprehensive view of a user's real-world experiences by capturing and organizing data from a variety of sources, and applying clustering and summarization techniques to organize the data in a manner that would make sense to a user.

The summarization performed by the summarization component 320 may be a process of condensing large amounts of data into a shorter and more concise form while preserving the essential meaning of the original data. The summarization component 320 may use heuristics to summarize a person's daily activities based on their perceived importance to the user, which may be defined by one or more user preference settings and/or historical user engagement data. The primary content item bundle creation component 322 labels at least a portion of the content item bundles 314 with primary signals (or primary labels) using factors such as the amount of time spent on an activity and user preferences.

The first step in the process of summarization is dominancy bundle creation, which involves labeling the content item bundles 314 based on their perceived importance to the user. The primary content item bundle creation component 322 uses heuristics to determine which signals are most important based on factors such as the amount of time spent on the activity and/or the user's preferences. For example, if a user spends a lot of time talking to their mom while walking, the primary content item bundle creation component 322 will identify the activity of “talking to mom while walking” as a primary signal and label the corresponding content item bundle accordingly with a primary label. In some aspects, the summarization component 320 includes a primary signal engine 327 that defines the primary user activity context for labeling. Additionally, the summarization component 320 may include a label engine 328 that provides a generalizable label definition to enable localization.

To improve personalization, the summarization component 320 utilizes several sources of information, such as photos, time of day, weather, and an aggregated layer to make inferences about the user's activities. The primary signal engine 327 may generate labels based on various cues. The primary content item bundle creation component 322 also considers the user's activities and the people around them to generate more accurate and meaningful labels.

In some aspects, the summarization component 320 may undertake a subprocess of determining when to split or merge clusters based on various dimensions such as time, location, and context. For example, if a person has a busy day and goes to five different places, the summarization component 320 may need to decide whether to create separate clusters for each place or merge them into one cluster. The summarization component 320 also needs to ensure that the clusters are accurate and relevant to the user. The summarization component 320 may utilize learned parameters to update the heuristics used for labeling and prompting the user. These parameters may be data-driven and can be updated over time as more information is collected. The summarization component 320 may use the sensing and bundle context to inform a prompt to get the user to start writing. For example if a trip bundle is created, once the user selects that bundle for writing, the summarization component 320 may cause display of a prompt that reads: “What about your trip is likely to stick with you?” Using the sensing and bundle context to inform a specific prompt can help make it easier to start writing and promote reflection.

The aggregation performed by each of the fine-grained aggregation component 324 and the coarse-grained aggregation component 326 may be a process of combining and grouping data into meaningful chunks, making it easier to process, analyze, and understand. For example, fine granularity aggregation performed by the fine-grained aggregation component 324 involves representing data at the lowest possible level of detail by forming chunks of data representing individual pieces of user events or activities, while coarse granularity aggregation performed by the coarse-grained aggregation component 326 involves grouping data together based on some criteria, such as time and/or location.

The fine granularity aggregation performed by the fine-grained aggregation component 324 is particularly useful when dealing with data that contains a large number of individual events or activities. For example, when tracking a person's daily activities, fine granularity aggregation may involve tracking each individual workout session, while coarse granularity aggregation may group them together as one workout session. Fine granularity aggregation allows for a more detailed analysis of individual events, making it easier to identify specific patterns or trends.

In contrast, the coarse granularity aggregation performed by the coarse-grained aggregation component 326 is useful when dealing with large volumes of data that needs to be summarized quickly. For example, when tracking the number of workouts over a period of time, coarse granularity aggregation may be used to group all workouts together as one session, making it easier to track overall trends. Coarse granularity aggregation can be more efficient than fine granularity aggregation since it involves processing fewer data points. Fine granularity aggregation is often preferred when the goal is to gain insights into specific activities or events, while coarse granularity aggregation is useful when the focus is on broader trends or patterns.

The aggregation layer comprised of the fine-grained aggregation and coarse-grained aggregation has potential use cases in various domains, such as health and fitness tracking and travel planning. In health and fitness tracking, the content item bundles creation component 310 can cluster data based on several parameters (e.g., one or more of proximity in time and location, bundle ranking factors, user ranking factors, theme, user demographics, population density, or environment type) to create content item bundles representing individual workouts or groups of workouts that occurred in the same location. Additionally, the summarization component 320 can use the type of exercise as an additional variable in the clustering process, allowing for fine granularity aggregation performed by the fine-grained aggregation component 324 based on the user's exercise habits. In travel planning, the content item bundles creation component 310 can cluster data based on several parameters (e.g., one or more of proximity in time and location, bundle ranking factors, user ranking factors, theme, user demographics, population density, or environment type) to create content item bundles representing individual days or groups of days that occurred in the same location. Additionally, the summarization component 320 can use the type of activity as an additional variable in the clustering process, allowing for fine granularity aggregation performed by the fine-grained aggregation component 324 based on the user's travel preferences.

By using pre-processing and pattern detection to filter out noise and identify useful signals, and then using summarization to identify overlapping signals indicative of primary signals, the system 300 can help to make sense of large amounts of data and provide insights into complex activities and events. The use of content item bundles and dominancy models can be useful in this context, allowing for the creation of customized bundles that are tailored to the user's specific needs and preferences. Overall, the choice between fine and coarse granularity aggregation depends on the specific use case and the user's preferences. In some cases, a combination of fine and coarse granularity aggregation may be used to provide a more comprehensive analysis of the data.

The filtering performed by the filtering and ranking component 330 may be a process that is used to sort through a large volume of data and select only the most relevant pieces of information. For example, the filtering process may be based on time and quality. The filtering process may help determine which of the content item bundles 314 are included in the user's recent tab (e.g., a first user interface (UI) element 340 as illustrated in FIG. 3B), which is a feature that provides users with a more streamlined way of accessing the information that is most important to them.

In one or more implementations, the filtering component 332 receives data directly from the fine-grained aggregation component 324, or it may obtain stored fine-grained aggregation data from the second event bundle store repository 306. The filtering component 332 may look back over a period of about 4 weeks, for example, to determine which of the content item bundles 314 are recent. This time-based filtering process performed by the filtering component 332 can ensure that only the most relevant information in terms of time is included in the first UI element 340. Overall, the filtering process used in this system is designed to provide a more meaningful and streamlined way of organizing and understanding large volumes of signals. By filtering out noise and identifying primary bundles, the system helps users to more easily identify and prioritize the information that is most important to them.

The ranking performed by the ranking and personalization component 334 utilizes a ranking algorithm that determines which suggestions are displayed to users and in what order. The ranking algorithm uses Bayesian inference and takes into account user behavior and preferences to personalize the ranking of suggestions. The Bayesian personalized ranking is an algorithm used in personalized recommendations, and it learns from user behavior to adapt accordingly. In some aspects, the ranking and personalization component 334 has a ranking engine 336 that assists with ranking life content in conjunction with the ranking algorithm and bundle factors (e.g., recency, richness, distinctness, quality score, heuristics) as will be described with reference to FIG. 5.

Furthermore, the ranking and personalization component 334 also considers the user's past behavior when selecting which content suggestions to present. For example, if the user has previously written a journal entry about a particular suggestion or marked a suggestion as uninteresting, the ranking algorithm can take that into account when ranking suggestions. This approach allows the system 300 to personalize the suggested topics to the user's preferences and habits, ensuring that the user is presented with suggestions that are more likely to be of interest to them.

In one or more implementations, the ranking and personalization component 334 receives data directly from the coarse-grained aggregation component 326, or it may obtain stored coarse-grained aggregation data from the second event bundle store repository 306. In other implementations, the ranking and personalization component 334 also receives data directly from the fine-grained aggregation component 324, or it may obtain stored fine-grained aggregation data from the second event bundle store repository 306. By taking into account a variety of factors, such as heuristics, time factors, user engagement, and diversity, the algorithm is able to offer the most relevant and interesting suggestions to the user. This encourages users to continue using the application and write about their experiences, which ultimately leads to a more engaging and fulfilling user experience.

The system 300 feeds the output of the filtering component 332 to the UI of the journaling application for display on the first UI element 340, and system 300 feeds the output of the ranking and personalization component 334 to the UI of the journaling application for display on a recommended tab (e.g., a second UI element 342 as illustrated in FIG. 3B). In one or more implementations, the data presented to the user is an aggregation of content that pertains to a particular detected event, which is labeled with the primary label. For example, the first UI element 340 provides users with a comprehensive view of all past data and recent events in a time-sorted order, while the second UI element 342 highlights the most important data for users to focus on and includes a set of content suggestions for the user to write about. For example, if a user is reviewing their recent vacation, the recent tab may display all photos, notes, and other data from the trip. In one or more implementations, the ranking and personalization component 334 identifies the highest-ranked content suggestion representing the most important or interesting moments from the trip and highlight them in the second UI element 342 for the user to focus on when writing about their trip. In one or more other implementations, the ranking and personalization component 334 summarizes all of the significant events from a trip into a single course trip bundle for display in the second UI element 342. In one or more other implementations, the second UI element 342 may include suggestions that are text only, and may include a rotating set of writing prompts. In some aspects, these writing prompts may be informed by underlying sensing algorithms. For example, if the preprocessing component 312 detects that a user has been spending a significant amount of time at home recently, the second UI element 342 can present a writing prompt that prompts the user to reflect on home related topics, or if the preprocessing component 312 detects that a user has been around lots of people recently, the second UI element 342 can present a writing prompt that prompts the user to write about social related topics.

In one or more implementations, the first UI element 340 is designed to provide users with time-sorted content suggestions for journaling representing an overview of their recent primary user activities without having to scroll through every single event or activity. Instead, the filtering component 332 identifies key events from each day and sorts them in chronological order so that users can see what they have been up to recently. For instance, if a user went on a hiking trip yesterday and had a dinner party the day before, these events would be highlighted and shown in the first UI element 340.

Additionally, the ranking and personalization component 334 includes a learning engine 338 that learns and personalizes content suggestions for reflection to the user in conjunction with the ranking algorithm. The system 300 may utilize machine learning techniques to learn the user's preferences and habits based on their past behavior. For instance, if the user tends to write about particular activities, such as biking workouts, the system 300 will rank events or entries related to such activities higher in the second UI element 342. The ranking and personalization component 334 also considers broader categories such as photo memories and general reflections that can be used to personalize the reflection.

By utilizing the sensor data collected from user electronic devices, the system 300 can provide a more personalized and concise view of a user's life. The inference model used to determine proximity to devices associated with notable people in a user's life, as well as unusual patterns in user behavior, can improve the accuracy and effectiveness of the system's recommendations. By analyzing data obtained from multiple sensors and sources, the system 300 can provide a more complete and nuanced understanding of a user's behavior and preferences. This enables users to better understand their behavior and make more informed decisions about their daily activities. Additionally, the system 300 employs various algorithms, such as routine detection and anomaly detection, to detect unusual patterns in a user's behavior. This can help the system 300 make more relevant and personalized recommendations to the user. The subject technology provides a powerful and innovative system 300 for analyzing and summarizing data from a variety of sensors on a user device. The ability to group and bundle related activities can also simplify the user experience and make it easier to understand patterns and trends in behavior. The ranking algorithm used by the system 300 can further improve the technical advantages of the system by taking into account a variety of factors, including the recency, distinctiveness, richness, and quality of the recommendations, as well as user engagement and diversity. The system's ability to detect routine and anomalous events, group related activities into bundles, and recommend events and activities to the user based on a variety of factors makes it a valuable tool for anyone seeking to better understand their behavior and patterns of activity. In this regard, the subject technology can make journaling more accessible and convenient for users, allowing them to create a personal record of their lives in a fun and engaging way. With the help of smart journaling suggestions, users can easily incorporate journaling into their daily routine without feeling overwhelmed. The subject technology also includes features that enhance the user's journaling experience, such as multimedia elements and reminders to write. Overall, the subject technology provides a framework for generating personalized and relevant content suggestions based on life moments, making journaling a more convenient and tailored experience for users. The system 300 can ensure that users can easily access and organize their past experiences while highlighting the most important data for them to focus on. This way, users can reflect on their lives and write about their experiences in a meaningful way.

FIG. 3C illustrates an example modular computing architecture 350 for a system providing dynamic presentation of content suggestions for annotation in accordance with one or more implementations. In one or more implementations, the modular computing architecture 350 may be implemented all or in part by the electronic device 120. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The modular computing architecture 350 may include an events creation component 354, a pattern detector component 356, a bundling and labeling component 358, a summarization component 360, and a ranking component 362. In one or more implementations, the modular computing architecture 350 may receive data from one or more source service provider interfaces (SPIs) 352 and may output, e.g., one or more content item bundle suggestions, for presentation by a user interface (UI) element 364 on behalf of an application (app) 366.

In one or more implementations, the pattern detector component 356 may perform one or more of the operations discussed above with respect to the pre-processing component 312, the bundling and labeling component 358 may perform one or more of the operations discussed above with respect to the content item bundle creation component 310, the summarization component 360 may perform one or more of the operations discussed above with respect to the summarization component 320, and the ranking component 362 may perform one or more operations discussed above with respect to the ranking and personalization component 334.

The events creation component 354 may generate events from data received and/or obtained from the one or more source service provider interfaces (SPIs) 352, e.g., in the manner described above with regard to the event store repository 302. The events generated by the events creation component 354, and/or access thereto, may be provided to the bundling and labeling component 358 and the pattern detector component 356. The bundling and labeling component 358 may identify and summarize recognizable events and/or combination of events (e.g., moments) from users' lives by combining event data from multiple different sources (e.g., location, photos, workouts, media, and the like), and may automatically generate user-interpretable text labels for moments, as described above.

The bundling and labeling component 358 may group events by time and context (e.g., location) using heuristics, parametric models and/or unsupervised learning, as described above. In one or more implementations, the bundling and labeling component 358 may personalize models to account for variations in users' lives (e.g. adjust location-related thresholds based on the different densities of urban/suburban/rural settings). In one or more implementations, the bundling and labeling component 358 may utilize generalized heuristics and templates for text label generation, as described above. The bundling and labeling component 358 may provide content item bundles to the summarization component 360 and to the ranking component 362, e.g., as described above for use as suggestions for journaling topics.

The ranking component 362 may score events and/or combination of events (e.g., moments) for relevance as content suggestions (e.g. for journaling). The scores determined by the ranking component 362 may be used to determine the prominence of particular content suggestions for presentation in the UI element 364, such as sort order, display size, and the like. In one or more implementations, the ranking component 362 may utilize one or more machine learning models/algorithms in the manner described in more detail herein. For example, the ranking component 362 may utilize a client-server algorithm architecture where a coarse model is generated server-side based on a large user population and then the coarse model is refined (e.g., re-trained) on-device based on user behavior over time. The ranking component 362 may also utilize a feature discovery mechanism to identify metadata that corresponds to events and/or moments that are relevant and/or interesting to users.

The pattern detector component 356 may utilize the events created by the events creation component 354 (and/or content item bundles) to identify patterns in users' lives (e.g., routines, schedules, anomalies/deviations from routine, and trends), e.g., generically across many sources of event data. The pattern detector component 356 may provide one or more inputs to the ranking component 362 that may be used for relevance scoring/ranking as described further herein. The pattern detector component 356 may also be used to create alternate types of suggestions in the form of insights that are then provided as input to the bundling and labeling component 358. In one or more implementations, the pattern detector component 356 may utilize privacy-preserving algorithms that minimize stored patterns of a user's event (e.g., life) data. In one or more implementations, the pattern detector component 356 may further incorporate custom combinations of pattern detection algorithms in addition to parameter tuning to optimize for interpretability by users.

Although the components of the modular computing architecture 350 may perform operations similar to those described above with respect to FIGS. 3A-B, the modular computing architecture 350 be designed such that components of the architecture 350 can be used for additional purposes other than the system for providing dynamic presentation of content suggestions.

For example, the bundling and labeling component 358 may generate recommendations for additional applications providing source event data, such as recommending media based on when and/or where it is often consumed. The bundling and labeling component 358 may also be used, for example, to suggest and/or auto-populate consumer reviews based on content bundled from the user's device (e.g., auto-populate a restaurant recommendation with photos, music, and other content). Similarly, the ranking component 362 may score events in additional applications providing source event data, such as a relevance score of photos based on the relevance of an associated moment.

The pattern detector component 356 may also be used for additional applications, such as generating contextual schedule recommendations (e.g., recommend workout timing based on users' detected life patterns). The pattern detector component 356 may also be used to optimize notification scheduling for users' life patterns, such as to automate device mode (e.g., focus mode) configurations. For example, a user may configure their device differently depending on whether they are at work or at home and the pattern detector component 356 may be used to identify these different configurations and automate the implementation thereof. The pattern detector component 356 may also be used to trigger prompts, or check-ins, based on detected deviations in a user's regular routine(s), such as prompting the user “do you wish to adjust your reminder schedule for X?” when a deviation in an associated routine is detected.

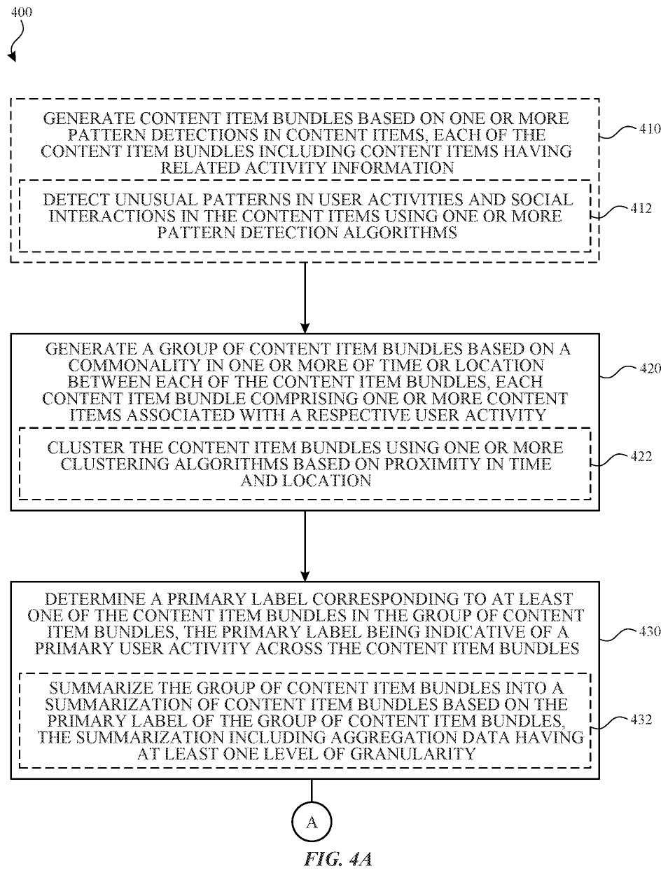

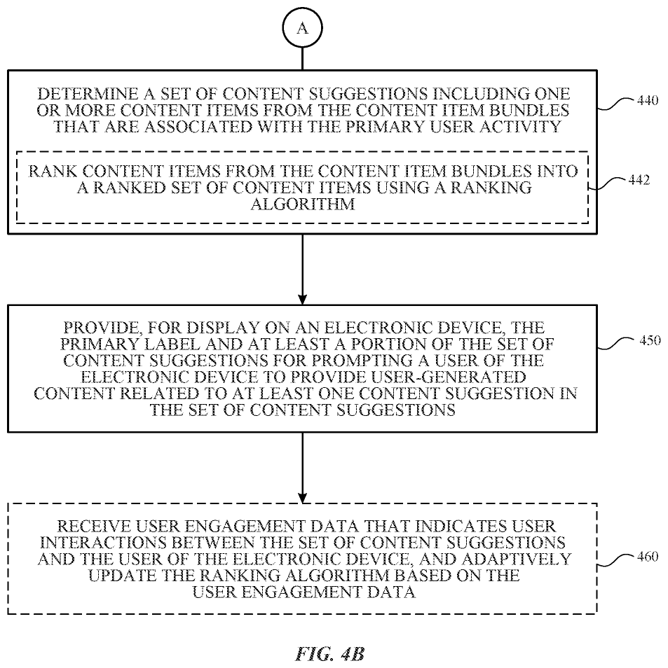

FIGS. 4A and 4B are flow charts of an example process 400 that may be performed for generating dynamic presentation of content suggestions for annotation in accordance with one or more implementations. For explanatory purposes, the process 400 is primarily described herein with reference to the electronic device 110 of FIG. 1. However, the process 400 is not limited to the electronic device 110 of FIG. 1, and one or more blocks (or operations) of the process 400 may be performed by one or more other components of other suitable devices and/or servers. Further for explanatory purposes, some of the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

As illustrated in FIG. 4A, at block 410, the electronic device 110 can generate a plurality of content item bundles based on one or more pattern detections in a plurality of content items, as described herein in connection with the content item bundles creation component 310 of FIG. 3A. In some aspects, each of the plurality of content item bundles includes one or more content items associated with a different type of user activity or event. In some aspects, at block 412, the electronic device 110 can detect unusual patterns in user activities and social interactions in the plurality of content items using one or more pattern detection algorithms, such as by using the statistical algorithms to analyze collected data for routine detection, anomaly detection, trend detection, and the duration and frequency of activities, social interactions, and changes in user behavior.

At block 420, the electronic device 110 can generate a group of content item bundles based on a commonality in one or more of time or location between each of the content item bundles, as described herein in connection with the summarization component 320 of FIG. 3A. In some aspects, each content item bundle includes one or more content items, such as photos, maps, workout information, etc., associated with a respective user activity. In one or more implementations, at block 422, the electronic device 110 can cluster the content item bundles using one or more clustering algorithms based on one or more of proximity in time and location, bundle factors, user factors, theme, user demographics, population density, or environment type.

At block 430, the electronic device 110 can determine a primary label corresponding to at least one of the content item bundles in the group of content item bundles, as described herein in connection with the primary content item bundle creation component 322 of FIG. 3A. In some aspects, the primary label is indicative of a primary user activity across the content item bundles. In one or more implementations, at block 432, the electronic device 110 can summarize the group of content item bundles into a summarization of content item bundles based on the primary label of the group of content item bundles, as described herein in connection with the fine-grained aggregation component 324 and coarse-grained aggregation component 326 of FIG. 3A. In some aspects, the summarization may include aggregation data having at least one level of granularity. For example, the electronic device can aggregate the group of content item bundles into different aggregation data having respective levels of aggregation granularity. In an aspect, the electronic device can perform a fine granularity aggregation of the group of content item bundles associated with the primary label to generate fine-grained aggregation data. In another aspect, the electronic device 110 can perform a coarse granularity aggregation of the group of content item bundles associated with the primary label to generate coarse-grained aggregation data.

As illustrated in FIG. 4B, at block 440, the electronic device can determine a content suggestion that includes one or more content items from the content item bundles that are associated with the primary user activity. In some implementations, the electronic device can determine a set of content suggestions that includes multiple different suggestions for journaling, where each of the content suggestions is associated with a different primary user activity.

In one or more implementations, at block 442, the electronic device 110 can rank a plurality of content items from the content item bundles that are associated with different primary user activities (or identified with different primary labels) into a ranked set of content items using a ranking algorithm, as described herein in connection with the ranking and personalization component 334 of FIG. 3B. In an aspect, the electronic device 110 can rank the coarse-grained aggregation data into a ranked set of content suggestions based on a plurality of factors associated with the user, in which the set of content suggestions includes the ranked set of content suggestions. In other aspects, the electronic device 110 can filter the fine-grained aggregation data into time-sorted filtered suggestions, in which the set of content suggestions includes the time-sorted filtered content suggestions.

In one or more implementations, the ranking and personalization component 334 (and/or the ranking component 362) may receive input from the pattern detector component 356 that may be used for ranking the plurality of content items. For example, the pattern detector component 356 (and/or the pattern detectors) may detect anomalous user behavior which may, for example, indicate that the behavior corresponds to a content item or content item bundle that the user may wish to journal about. Accordingly, based on this input the ranking component 362 may rank such a content item or content item bundle more highly than other content items or content item bundles. In one or more implementations, the pattern detector component 356 may also provide content items and/or content item bundles to the ranking and personalization component 334. Such content items and/or content item bundles may be identified based on, for example, their association with anomalous user behavior/activity which may be indicative of activities or events the user may wish to journal about.

At block 450, the electronic device 110 can provide, for display on the electronic device 110, the primary label and a portion of the one or more content items included in the content suggestion for prompting a user of the electronic device to provide user-generated content related to the content suggestion, as described herein in connection with the ranking and personalization component 334 and second UI element 342 of FIG. 3B. In some aspects, the electronic device 110 can receive one or more annotations comprising user-generated content associated with the at least one content suggestion in the set of content suggestions. Responsive to receiving the one or more annotations from the user, the electronic device 110 can store the one or more annotations in association with the group of content item bundles. Additionally, at block 460, the electronic device 110 can receive user engagement data that indicates user interactions between the content suggestion and the user, and adaptively update the ranking algorithm based on the user engagement data.

FIG. 5 illustrates an example computing architecture for a system ranking content suggestions in accordance with one or more implementations. The system 500 includes a ranking algorithm 550 that is optimized by the ranking and personalization component 334 (as described in conjunction with FIG. 3B) to determine which content suggestions a user is most likely to want to write about. The ranking algorithm 550 uses various inputs, such as bundle factors 510, user factors 530 and prior factors 540. The bundle factors 510 includes time factors 512 (e.g., recency), richness factor 514 (e.g., asset specificity), distinctness factor 516 (e.g., trends, anomalies), quality score factor 518, and heuristics factor 520 related to the inherent quality of the suggestion. The user factors 530 includes user engagement history factor 534 and bundle diversity factor 532. The prior factors 540 includes predefined bundle type order factor 542 and bundle type popularity factor 544.

The quality score factor 518 may refer to a measure of the confidence the system 500 has in the accuracy of a suggestion, and it is based on the sensing quality of the underlying data. If the system 500 has a low level of confidence in a suggestion's accuracy, it will assign a lower quality score, and the suggestion may not be presented to the user or may be given a lower priority. The algorithm used to determine the inherent quality of a suggestion takes into account several factors, including the user's preferences, past behavior, and at least part of the heuristics factor 520. For example, if the user tends to write about outings, the system 500 may prioritize suggestions related to outings. The system 500 also considers the distance of the outing from the user's home, as outings further away may be more interesting. The sensing quality score is also important in determining the quality score factor 518 of a suggestion. If the underlying data used to generate a suggestion is inaccurate or incomplete, the suggestion may not be relevant or accurate. For example, if the suggestion is based on GPS data that is inaccurate, the suggestion may not be useful to the user. In such cases, the quality score factor 518 may be low, and the suggestion may not be presented to the user or may be given a lower priority.

The heuristics factor 520 used are based on factors that make a smart suggestion more likely to be interesting for someone to journal about, such as the type of activity, length of the activity, and distance from home. The heuristics factor 520 may be used to evaluate the relevance of a suggestion to the user based on their previous interactions with the journaling application. These rules or guidelines are used to evaluate the quality of a suggestion, and may include factors such as the relevance of the suggestion to the user's interests, the duration of a phone call, the visit distance from home, the popularity of the suggestion, or any other factors that may affect the quality of the suggestion. For example, if the user frequently engages in outdoor activities, the heuristics factor 520 may prioritize suggestions related to hiking or camping over suggestions related to indoor activities.

The ranking algorithm 550 also takes into account the time factors 512, such as recent events, as well as user engagement signals from the user engagement history factor 534. For example, if a user has previously written a journal entry about a particular suggestion, it is seen as a positive signal and the suggestion is more likely to appear at the top of the list. The user engagement history factor 534 records the user's past preferences and interactions with the application, in order to suggest outings that are most likely to appeal to the user. For example, the user engagement history factor 534 considers the history of a user writing about bundles of a particular type. By tracking this data, the system can develop a better understanding of the user's preferences and interests, enabling it to offer tailored recommendations that are more likely to be relevant and useful.

The ranking algorithm 550 utilizes the bundle diversity factor 532 that incentivizes showing suggestions of multiple types at the top of the list. Even if a user has previously written about a particular type of activity, the ranking algorithm 550 can still attempt to offer suggestions of different types to ensure that the user does not become bored or disinterested in the journaling application. The bundle diversity factor 532 may refer to a measure of the variety of suggestions presented to the user. In some aspects, the bundle diversity factor 532 considers the frequency of a particular bundle type among the user's suggestions. The system 500 can ensure that users receive suggestions of different types to enhance their experience. For example, if a user has a preference for workouts, the system 500 can still prioritize displaying suggestions of other types as well, such as outings or events. The bundle diversity factor 532 can be implemented in various ways. For example, the ranking algorithm 550 may assign a higher weight to suggestions that are different from the user's previous selections, or it may prioritize showing suggestions that have not been shown recently. In this way, the system 500 can ensure that users are presented with a diverse range of options that are likely to appeal to them.

In addition, the ranking and personalization component 334 provides a ranking score that takes into account the quality score factor 518 as well as other factors, such as the relevance of the content item bundle to the user's preferences. In some aspects, the quality score factor 518 is used to filter out content item bundles that are not relevant to the user. The ranking score is used to determine the order in which the content item bundles are displayed to the user. For example, if the user frequently accesses data related to workouts, the system 500 may rank content item bundles related to workouts higher than other content item bundles.

The ranking algorithm 550 utilizes the prior factor 540, which is based on insights gained from research, analytics, and user experience. The system 500 analyzes this data to identify the types of outings that people most commonly prefer. For example, the predefined bundle type order factor 542 refers to a preferred ordering of content item bundles among the general population. Similarly, the bundle type popularity factor 544 may refer to a ranking of content item bundles by popularity among the general population.

The ranking algorithm 550 provides the ranking scores to a downstream ranking engine 560 to provide a ranked content item bundle list and/or top N content suggestions to a suggestion sheet 570. In some aspects, the suggestion sheet 570 may correspond to the second UI element 342 (as described in conjunction with FIG. 3B). By combining all of these factors, the ranking algorithm 550 provides more personalized and relevant suggestions to the user.

In some implementations, the ranking algorithm 550 can be used to improve the notification system for reminding users to journal. The ranking algorithm 550 can be used to determine which journal prompts or topics are most relevant or important to the user based on their engagement history and other factors. This information can then be used to personalize notifications and reminders, making them more effective and meaningful.

To achieve this, the ranking algorithm 550 takes into account various features such as the user's past engagement with different journal topics and the popularity of those topics among other users. For example, if a user frequently writes about their mother and beach walks, and these topics are also popular among other users, the ranking algorithm 550 may rank them higher in the user's suggestion list. The ranking algorithm 550 may also consider other factors like the time of day, location, and frequency of the user's journaling to determine which topics are most relevant at any given time.

Once the ranking algorithm 550 has ranked the topics or prompts, the system can then use this information to send personalized reminders to the user. For instance, if a user has a preference for daily reminders, the system may send a notification each day with the top three suggested topics based on the user's ranking. This way, the user is more likely to be reminded of topics that are relevant and interesting to them, rather than receiving generic or random content suggestions.

The use of the ranking algorithm 550 in conjunction with a notification system can help personalize reminders and make them more effective in prompting users to write. By taking into account the user's engagement history, popularity of topics, and other factors, the ranking algorithm 550 can provide more relevant and timely suggestions. This not only improves the user's experience with the journaling application but also helps them develop a consistent journaling habit.

In one or more implementations, the ranking algorithm 550 is a Bayesian personalized ranking algorithm. The ranking algorithm 550 receives the user's engagement history into account and interprets it as a signal of preference for certain topics over others. The framework of the Bayesian personalized ranking is used to combine the user engagement history factor 534 with other factors such as the distinctness factor 516, the heuristics factor 520, among others, to provide more personalized suggestions to the user.

In some aspects, the Bayesian personalized ranking algorithm uses a pairwise ranking approach, which involves ranking two items at a time and using the feedback from the user to determine which item is preferred. In one or more implementations, the user behavior about which suggestions the user taps on (or selects) feeds back to adaptively update the ranking algorithm 550 to personalize the suggestions towards the types of suggestions the user prefers most to write about. For instance, if a user frequently writes about workouts, the ranking algorithm 550 can learn and prioritize workout suggestions at the top of the suggestion sheet 570, whereas another user who loves to write about shared links that they have shared with their friends will tend to see those at the top of their suggestion sheet (or recommended tab). The system 500 can employ both population-level analytics and on-device learning. The population-level analytics provide data from users' past user interactions, and the on-device learning is designed to learn from an individual user's history of interaction with the journaling application. This adaptation process aims to personalize the ranking algorithm 550 towards the types of suggestions they most prefer to write about. Although a Bayesian personalized ranking algorithm is described with reference to the ranking algorithm 550, it should be appreciated that other types of personalized ranking algorithms may be implemented to operate as the ranking algorithm 550.

To implement the prior responses related to ranking with the ranking algorithm 550, a training dataset is created that contains information on user interactions with journaling suggestions. The dataset can include information on which suggestions the user engaged with (such as read, wrote about, or ignored), and the features associated with those suggestions. These features can include factors such as the topic of the suggestion, the date it was suggested, and the time of day it was suggested.

Once the dataset is created, the ranking algorithm 550 can be trained using a pairwise ranking approach. The ranking algorithm 550 can receive pairs of journaling suggestions and use the feedback from the user's past interactions to determine which suggestion is preferred. For example, if the user engaged with suggestion A but ignored suggestion B, the algorithm will infer that the user prefers suggestion A over suggestion B. In operation, the user engagement is recorded by the system 500, and is used to update the engagement score, Score_{Engagement}. In some aspects, the engagement score is updated if there is sufficient engagement history (e.g., N>5), and the time since the engagement score was last updated exceeds a predefined elapsed time (e.g., >28 days).

Once the ranking algorithm 550 has been trained, it can be used to rank journaling suggestions for the user. The ranking algorithm 550 can take into account the user's engagement history, as well as other features such as the topic of the suggestion and the time it was suggested, to determine which suggestions are most likely to be engaging for the user. These suggestions can then be presented to the user in order of rank, with the most engaging suggestions at the top of the list (e.g., ranked bundle list with top suggestions).

In some aspects, a Broyden-Fletcher-Goldfarb-Shanno (BFGS) quasi-Newton method can be implemented as an optimization algorithm used to optimize the results of the ranking algorithm 550. In some aspects, the ranking algorithm 550 can generate a probability distribution over pairs of items, and the BFGS algorithm can be used to optimize the parameters of the probability distribution. The BFGS algorithm is a gradient-based optimization method that uses a quasi-Newton approximation to the Hessian matrix to update the parameters of the probability distribution. The BFGS algorithm can start with an initial estimate of the parameters and iteratively updates them to minimize a loss function. In the case of the ranking algorithm 550, the loss function is typically the negative log-likelihood of the observed rankings.

To apply the BFGS algorithm to optimize the results of the ranking algorithm 550, the parameters of the probability distribution may first be initialized. This can be done using a random initialization or by using prior knowledge of the problem domain. Once the parameters have been initialized, the BFGS algorithm can be used to iteratively update the parameters to minimize the loss function. During each iteration of the BFGS algorithm, the gradient of the loss function is computed with respect to the parameters of the probability distribution. The gradient is then used to update the parameters of the probability distribution in the direction of steepest descent. The BFGS algorithm also maintains an approximation to the Hessian matrix, which is used to determine the step size for each update. The BFGS algorithm continues to iteratively update the parameters of the probability distribution until convergence is achieved, which is typically determined by a threshold on the change in the loss function or the norm of the gradient.

By using the BFGS algorithm to optimize the results of the ranking algorithm 550, the accuracy and performance of the ranking algorithm 550 can be improved by more effectively ranking items based on user interactions.

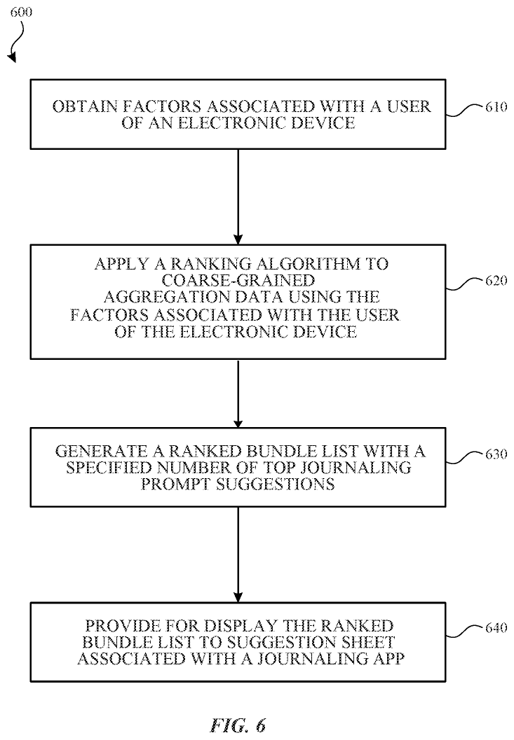

FIG. 6 is a flow chart of an example process 600 that may be performed for ranking content suggestions accordance with one or more implementations. For explanatory purposes, the process 600 is primarily described herein with reference to the electronic device 110 of FIG. 1. However, the process 600 is not limited to the electronic device 110 of FIG. 1, and one or more blocks (or operations) of the process 600 may be performed by one or more other components of other suitable devices and/or servers. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 610, the electronic device 110 can obtain a plurality of factors associated with a user of the electronic device 110, as described herein in connection with the bundle factors 510, user factors 530 and prior factors 540 of FIG. 5.

At block 620, the electronic device 110 can apply a ranking algorithm to aggregation data using the plurality of factors, as described herein in connection with the ranking algorithm 550 of FIG. 5. In one or more implementations, the ranking algorithm can be applied to coarse-grained aggregation data. In one or more other implementations, the ranking algorithm can be applied to fine-grained aggregation data.

At block 630, the electronic device 110 can generate a ranked bundle list with a specified number of top content suggestions, as described herein in connection with the downstream ranking engine 560 of FIG. 5.

At block 640, the electronic device 110 can provide for display the ranked bundle list to a suggestion sheet associated with a journaling application, as described herein in connection with the suggestion sheet 570 of FIG. 5.

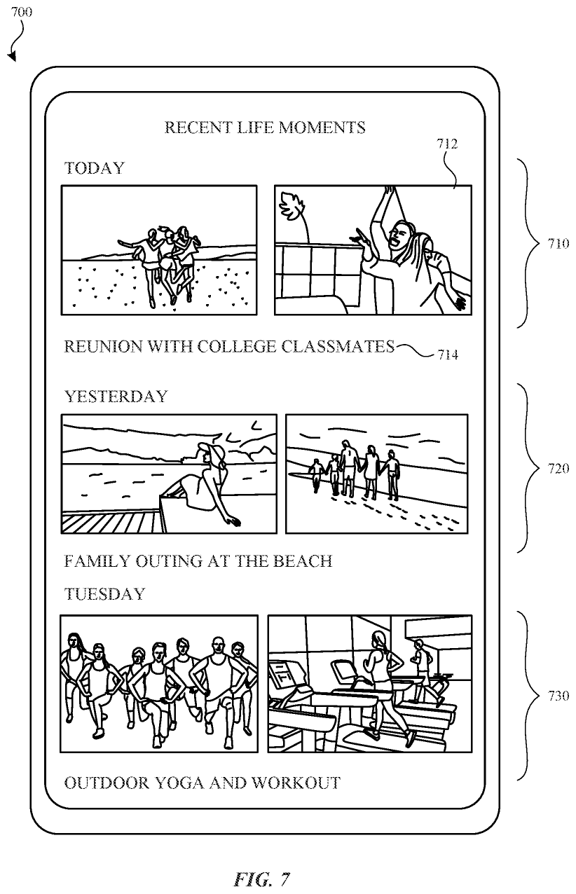

FIG. 7 illustrates an example use case in which content suggestions for annotation are generated based on a user activity timeline in accordance with one or more implementations. As illustrated in FIG. 7, a UI 700 of a journaling application shows time-based filtered content suggestions, as described in conjunction with the first UI element 340 of FIG. 3B. In an aspect, the UI 700 may correspond to, or include at least part of, the first UI element 340 of FIG. 3B. The first UI element 340 may include an arbitrary number of content suggestions that can be sequentially presented to the user upon the user interacting with the UI 700, such as by scrolling up the display pane. In some aspects, each of the content suggestions (e.g., 710, 720, 730) can include media such as images, video clips, audio clips, and the like, that enhance the user's interaction with the content suggestions.

As illustrated in FIG. 7, the UI 700 depicts recent life moments that correspond to a subset of personalized and relevant content item bundles sorted in time (or chronological order). In this regard, the content suggestions depicted in the UI 700 may be part of a set of content suggestions that include one or more content items from the content item bundles that are associated with a primary user activity. In one illustrative use case, the UI 700 includes a first content suggestion 710 that corresponds to life moments occurring on a given day, for example “Today,” which relate to one or more events including the primary user activity. In this case, the life moments being suggested in the first content suggestion 710 relate to a “reunion with college classmates” denoted by caption 714, which may be defined as the primary user activity and associated with a primary label. Additionally, the first content suggestion 710 also includes accompanying images 712 that relate to the suggested content. In this regard, the user is being encouraged to submit a new journal entry that relates to the first content suggestion 710.

Similarly, the UI 700 also includes a second content suggestion 720 that corresponds to life moments occurring on a prior day, for example “Yesterday,” which relate to a “family outing at the beach.” The UI 700 also includes a third content suggestion 730 that corresponds to life moments of the user occurring on an earlier date, for example “Tuesday,” which relate to “Outdoor Yoga and Workout.” In some aspects, each of the content suggestions 710, 720 and 730 may include a primary label that indicates the primary user activity respectively depicted in the content suggestions 710, 720 and 730. These content suggestions 710, 720 and 730 are presented to the user in chronological order or in a user-preferred order in time, with the most recent events typically presented on top. In operation, the user may select one of these content suggestions. Responsively, the electronic device 110 may generate (or least facilitate initiation of), a journal entry with content related to the content suggestion for the user to resume writing about in the journaling application. In various implementations, each of the time-sorted content suggestions may include content related to one event (or content item bundle), or may include a combination of multiple events (or multiple content item bundles).

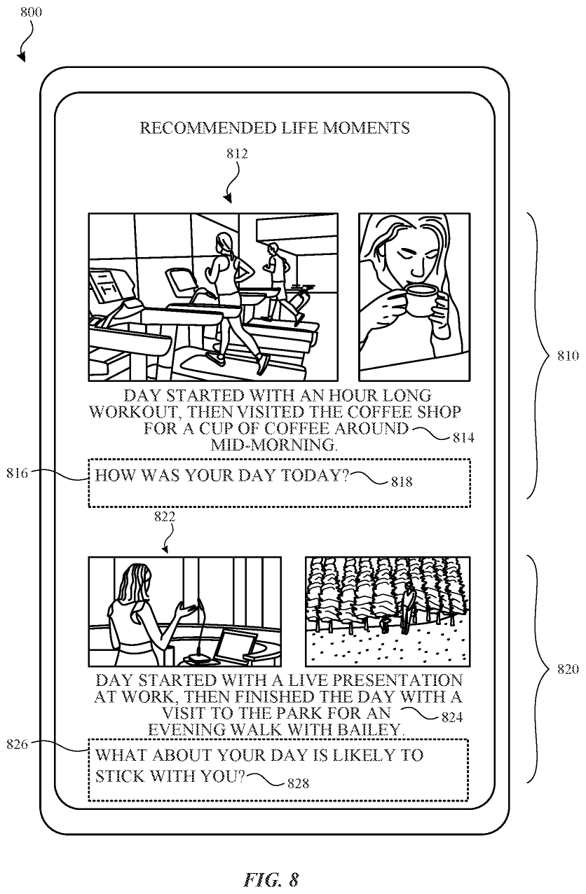

FIG. 8 illustrates an example use case in which content suggestions for annotation are generated to recommend a journaling entry for a user in accordance with one or more implementations. As illustrated in FIG. 8, a UI 800 of a journaling application shows filtered content suggestions by relevancy and most interest to the user, as described in conjunction with the second UI element 342 of FIG. 3B. In an aspect, the UI 800 may correspond to, or include at least part of, the second UI element 342 of FIG. 3B. The second UI element 342 may include an arbitrary number of content suggestions that can be sequentially presented to the user upon the user interacting with the UI 800, such as by scrolling up the display pane. In some aspects, each of the content suggestions (e.g., 710, 720, 730) can include media such as images, video clips, audio clips, and the like, that enhance the user's interaction with the content suggestions.

As illustrated in FIG. 8, the UI 800 depicts personalized life moments that correspond to a curated subset of relevant content item bundles that highlight the most important data for the user to focus on and write about. In this regard, the content suggestions depicted in the UI 800 may be part of a set of content suggestions that include one or more content items from the content item bundles that are associated with a primary user activity. In one illustrative use case, the UI 800 includes a first content suggestion 810 that corresponds to life moments 812, which relate to one or more events determined to be of most interest to the user based on several factors as described with reference to FIGS. 3 and 5. In this case, the life moments 812 being suggested relate to one or more user activities that occurred during a defined period of time (e.g., one full day).

For example, the life moments 812 describe a “Day started with an hour-long workout, then visited the coffee shop for a cup of coffee around mid-morning” as denoted by caption 814. The first content suggestion 810 includes a journal entry section 816 along with a prompt 818 that reads “How was your day today?”. In this regard, the user is being encouraged by the prompt 818 to submit a new journal entry that relates to the first content suggestion 810. In some aspects, the first content suggestion 810 may include a primary label that indicates the primary user activity depicted in the first content suggestion 810. Similarly, the UI 800 also includes a second content suggestion 820 depicting life moments 822 that are determined to have the second most important data to the user. For example, the life moments 822 describe a “Day started with a live presentation at work, then finished the day with a visit to the park for an evening walk with Bailey” as denoted by caption 824. The second content suggestion 820 includes a journal entry section 826 along with a prompt 828 that reads “What about your day is likely to stick with you?”. In this regard, the user is being encouraged by the prompt 828 to submit a new journal entry that relates to the second content suggestion 820. In some aspects, the second content suggestion 820 may include a primary label that indicates the primary user activity depicted in the second content suggestion 820.

These content suggestions 810 and 820 are presented to the user in a ranked order using a ranking algorithm (e.g., the ranking algorithm 550 of FIG. 5), with the highest-ranked content suggestions representing the most important (or most interesting) suggestions presented on top. In operations, the user may select one of these content suggestions. Responsively, the electronic device 110 may generate (or least facilitate initiation of), a journal entry with content related to the content suggestion for the user to resume writing about in the journaling application. In various implementations, each of the ranked content suggestions may include content related to one event (or content item bundle), or may include a combination of multiple events (or multiple content item bundles).

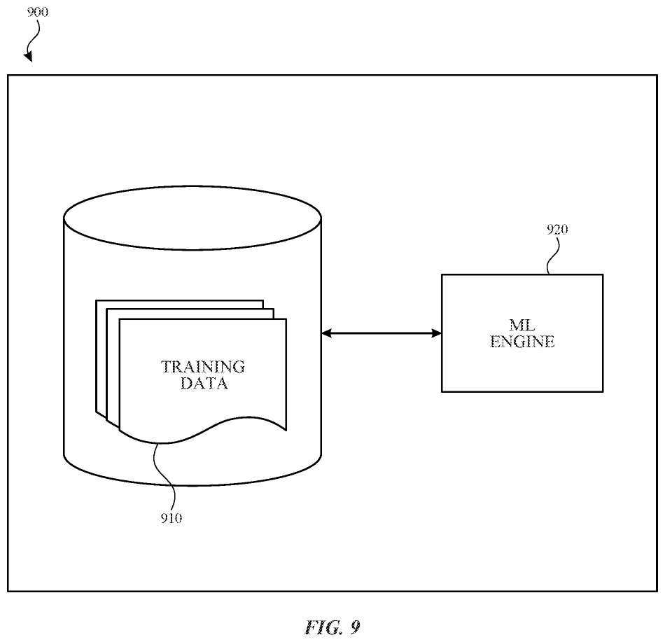

FIG. 9 illustrates an example computing architecture for a system providing dynamic presentation of content suggestions for annotation using machine learning models, in accordance with one or more implementations. For explanatory purposes, the computing architecture is described as being provided by an electronic device 900, such as by a processor and/or memory of the server 120, or by a processor and/or a memory of any other electronic device, such as the electronic device 110. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The machine learning model can be trained and implemented to perform actions of a system for providing personalized and relevant content suggestions. The system can perform data collection by collecting and curating a large dataset that contains examples of user interactions with a journaling application, such as user inputs, time of interaction, type of interaction, and user feedback.

The system can perform data pre-processing by pre-processing the collected data to make it suitable for training the machine learning model. This includes data cleaning, normalization, feature extraction, and feature engineering. As illustrated, the electronic device 900 includes training data 910 for training a machine learning model. Training data 910 may include activity information associated with activities (also referred to as events), such as life moments. For example, the activity information may include user activity measurements associated with user interactions and/or other user engagement activities based on time and/or location. As an example, the training data 910 may include data from, e.g., hundreds or thousands of users and/or hundreds, thousands, or millions of user activities over the course of days, weeks, months or years. In one or more implementations, training data 910 may include training data obtained by a device on which a trained machine learning (ML) model 920 is deployed and/or training data obtained by other devices.

Training data 910 may include demographic information (e.g., age, gender, personal preferences, etc.) for a user of the electronic device 110, and/or a population of other users. The activity information may also include locations (e.g., an indoor location, an outdoor location, a geographical location such as a Global Positioning System (GPS) location, or other location information) of one or more portions of an activity and/or weather conditions at the time of an activity. The activity information may have been obtained over the course of multiple (e.g., many) prior activities by a user of the electronic device 110, and/or by a population of other users, such as users that were wearing wearable devices during prior activities, and authorized collection of anonymized activity collections from the wearable devices. In one or more implementations, activity collections included in the training data 910 may include places visited, contacts and/or other people visited, a routine activity, a workout length in time or in distance, health measurements, and/or the like.

The system can perform model selection by selecting a suitable machine learning algorithm, such as decision trees, neural networks, or support vector machines, that can learn from the pre-processed data and perform the desired actions, such as suggesting journal entries or ranking journaling suggestions. The system can perform training of the machine learning model by training the selected model on the pre-processed data. This involves splitting the data into training, validation, and test sets, setting hyperparameters, and using an optimization algorithm to minimize the model's loss or error on the training data. In an example, the electronic device 110 and/or the server 120 may utilize one or more machine learning algorithms that uses training data 910 for training the ML model 920.

The system can perform model evaluation by evaluating the trained model on the validation and test sets to ensure that it performs well and generalizes to new data. This includes calculating metrics such as accuracy, precision, recall, and F1-score. The system can perform model deployment once the trained model has been evaluated and validated. The model can be deployed in the journaling application to perform the desired actions. This involves integrating the model into the journaling application's codebase and providing a user interface for users to interact with the model's outputs. Overall, training and implementing a machine learning model to perform actions in a journaling application may include a combination of data collection, pre-processing, model selection, training, evaluation, and deployment. It also may entail careful consideration of ethical and privacy concerns related to collecting and processing user data.

As described above, one aspect of the present technology is the gathering and use of data available from specific and legitimate sources for generating smart journaling suggestions. The present disclosure contemplates that in some instances, this gathered data may include personal information data that uniquely identifies or can be used to identify a specific person. Such personal information data can include audio data, demographic data, location-based data, online identifiers, telephone numbers, email addresses, home addresses, biometric data or records relating to a user's health or level of fitness (e.g., vital signs measurements, medication information, exercise information, motion information, heartrate information workout information), date of birth, or any other personal information.

The present disclosure recognizes that the use of such personal information data, in the present technology, can be used to the benefit of users. For example, the personal information data can be used for generating smart journaling suggestions.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates aspects in which users selectively block the use of, or access to, personal information data. That is, the present disclosure contemplates that hardware and/or software elements can be provided to prevent or block access to such personal information data. For example, in the example of generating smart journaling suggestions, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

FIG. 10 illustrates an electronic system 1000 with which one or more implementations of the subject technology may be implemented. The electronic system 1000 can be, and/or can be a part of, the electronic device 110, and/or the server 120 shown in FIG. 1. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In one or more implementations, the processes of the subject disclosure are stored in the system memory 1004, the permanent storage device 1002, and/or the ROM 1010. From these various memory units, the one or more processing unit(s) 1012 retrieves instructions to execute and data to process in order to execute the processes of one or more implementations.

The bus 1008 also connects to the input device interface 1014 and output device interface 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes, such as the electronic device 110 shown in FIG. 1, through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
generating a group of content item bundles based on a commonality in one or more of time or location between each of the content item bundles, each content item bundle comprising one or more content items associated with a respective user activity;
determining a primary label corresponding to at least one of the content item bundles in the group of content item bundles, the primary label being indicative of a primary user activity across the content item bundles;
determining a content suggestion comprising one or more content items from the content item bundles that are associated with the primary user activity; and
providing, for display on an electronic device, the primary label and a portion of the one or more content items in the content suggestion for prompting a user of the electronic device to provide user-generated content related to the content suggestion.

2. The method of claim 1, further comprising generating the content item bundles based on one or more pattern detections in a plurality of content items, each of the content item bundles comprising content items having related activity information.

3. The method of claim 2, wherein the generating the content item bundles comprises detecting unusual patterns in one or more of user activities, user visited locations or social interactions in the plurality of content items using one or more pattern detection algorithms.

4. The method of claim 1, wherein the determining the content suggestion further comprises ranking a plurality of content items from the content item bundles into a ranked set of content suggestions using a ranking algorithm.

5. The method of claim 4, further comprising:
receiving user engagement data that indicates user interactions between the ranked set of content suggestions and the user of the electronic device; and
adaptively updating the ranking algorithm based on the user engagement data.

6. The method of claim 1, wherein the generating the group of content item bundles comprises clustering the content item bundles using one or more clustering algorithms based on one or more of proximity in time and location, bundle factors, user factors, theme, user demographics, population density, or environment type.

7. The method of claim 1, further comprising summarizing the group of content item bundles into a summarization of content item bundles based on the primary label of the group of content item bundles, the summarization comprising aggregation data having at least one level of granularity.

8. The method of claim 7, wherein the summarizing the group of content item bundles comprises aggregating the group of content item bundles into different aggregation data having respective levels of aggregation granularity.

9. The method of claim 8, wherein the aggregating comprises:
performing a fine granularity aggregation of the group of content item bundles associated with the primary label to generate fine-grained aggregation data; and
performing a coarse granularity aggregation of the group of content item bundles associated with the primary label to generate coarse-grained aggregation data.

10. The method of claim 9, further comprising filtering the fine-grained aggregation data into a time-sorted set of content items, wherein the determining the content suggestion comprises determining a set of content suggestions that includes the time-sorted set of content items.

11. The method of claim 9, further comprising ranking the coarse-grained aggregation data into a ranked set of content items based on a plurality of factors associated with the user of the electronic device, wherein the determining the content suggestion comprises determining a set of content suggestions that includes the ranked set of content items.

12. The method of claim 1, further comprising:
receiving one or more annotations comprising user-generated content associated with the content suggestion; and
storing the one or more annotations in association with the group of content item bundles.

13. The method of claim 1, wherein each of the content item bundles comprises one or more content items associated with a different type of user activity or event.

14. A device, comprising:
a memory; and
one or more processors configured to:
generate a group of content item bundles based on a commonality in one or more of time or location between each of the content item bundles, each content item bundle comprising one or more content items associated with a respective user activity;
determine a primary label corresponding to at least one of the content item bundles in the group of content item bundles, the primary label being indicative of a primary user activity across the content item bundles;
determine a content suggestion comprising one or more content items from the content item bundles that are associated with the primary user activity; and
provide, for display on an electronic device, the primary label and a portion of the one or more content items in the content suggestion for prompting a user of the electronic device to provide user-generated content related to at least one content suggestion in the content suggestion.

15. The device of claim 14, wherein the one or more processors configured to generate the content item bundles by detecting unusual patterns in user activities and social interactions in a plurality of content items using one or more pattern detection algorithms, each of the content item bundles comprising content items having related activity information.

16. The device of claim 14, wherein the one or more processors are further configured to:
receive user engagement data that indicates user interactions between the content suggestion and the user of the electronic device; and
adaptively update a ranking algorithm based on the user engagement data.

17. The device of claim 14, wherein the one or more processors are further configured to summarize the group of content item bundles into a summarization of content item bundles based on the primary label of the group of content item bundles by aggregating the group of content item bundles into different aggregation data having respective levels of aggregation granularity.

18. The device of claim 17, wherein the one or more processors configured to aggregate are further configured to:
perform a fine granularity aggregation of the group of content item bundles associated with the primary label to generate fine-grained aggregation data; and
perform a coarse granularity aggregation of the group of content item bundles associated with the primary label to generate coarse-grained aggregation data.

19. The device of claim 14, wherein the one or more processors are further configured to aggregate are further configured to:
receive one or more annotations comprising user-generated content associated with the content suggestion; and
store the one or more annotations in association with the group of content item bundles.

20. A non-transitory machine-readable medium comprising code that, when executed by a processor, causes the processor to perform operations comprising:
generating a group of content item bundles based on a commonality in one or more of time or location between each of the content item bundles, each content item bundle comprising one or more content items associated with a respective user activity;
determining a primary label corresponding to at least one of the content item bundles in the group of content item bundles, the primary label being indicative of a primary user activity across the content item bundles;
determining a content suggestion comprising one or more content items from the content item bundles that are associated with the primary user activity; and
providing, for display on an electronic device, the primary label and a portion of the one or more content items in the content suggestion for prompting a user of the electronic device to provide user-generated content related to at least one content suggestion in the content suggestion.
